(19) United States
(12) Patent Application Publication
(10) Pub. No.: US 2008/0147543 A1
(43) Pub. Date: Jun. 19, 2008

(54) BILLING AND PAYMENT METHODS FOR A TRANSACTION BETWEEN A RETAIL MERCHANT AND A RETAIL CONSUMER

(76) Inventor: Wayne M. Doran, Kitchener (CA)

Correspondence Address: Intellectual Property Section;Law Department, NCR Corporation, 1700 South Patterson Blvd., Dayton, OH, 45479-0001, US

(21) Appl. No.: 11/610,105

(22) Filed: Dec. 13, 2006

(51) Int. Cl. G06Q 30/00

(52) U.S. Cl. 705/40

(57) ABSTRACT

A method is provided of a retail merchant in a transaction conducted between the retail merchant and a retail consumer. The method comprises receiving an on-line request from the retail consumer to make payment for the transaction, prompting the retail consumer to key in details associated with a check to be used by the retail consumer to make payment for the transaction, receiving check details from the retail consumer, prompting the retail consumer to scan at least one image of the check, prompting the retail consumer to attach the at least one check image to the transaction, and receiving the transaction along with the attached check image.

### BACKGROUND

The present invention relates to transactions conducted between a retail merchant and a retail consumer, and is particularly directed to billing and payment methods for a transaction between a retail merchant and a retail consumer.

In a typical transaction between a retail merchant and a retail consumer, the merchant sends a bill to the consumer for having purchased goods or services. The consumer writes a check and sends the check to the merchant to make payment for the purchased goods or services. The merchant then deposits the check in a bank. Alternatively, the merchant may capture images of the check, and then prepare an electronic deposit transaction using the captured check images. The merchant transmits the electronic deposit transaction to the bank for deposit. It would be desirable to streamline the billing and payment processing methods of the retail merchant when a transaction for the purchase of goods or services is conducted between the retail merchant and the retail consumer.

### SUMMARY

In accordance an embodiment of the present invention, a method of a retail merchant in a transaction conducted between the retail merchant and a retail consumer comprises receiving an on-line request from the retail consumer to make payment for the transaction, prompting the retail consumer to key in details associated with a check to be used by the retail consumer to make payment for the transaction, receiving check details from the retail consumer, prompting the retail consumer to scan at least one image of the check, prompting the retail consumer to attach the at least one check image to the transaction, and receiving the transaction along with the attached check image.

### BRIEF DESCRIPTION OF THE DRAWINGS

In the accompanying drawings:

FIG. 1 is a flow diagram depicting a known method of a retail consumer receiving a bill from a retail merchant and making payment to the retail merchant;

FIG. 2 is a flow diagram depicting steps of a known billing and payment processing method used by a retail merchant;

FIG. 3 is a flow diagram depicting steps of another known billing and payment processing method used by a retail merchant;

FIG. 4 is a flow diagram depicting steps of a retail consumer receiving a bill from a retail merchant and making payment to the retail merchant in accordance with an embodiment of the present invention; and

FIG. 5 is a flow diagram depicting steps of a billing and payment method used by a retailer merchant and in accordance with the embodiment illustrated in FIG. 4.

### DETAILED DESCRIPTION

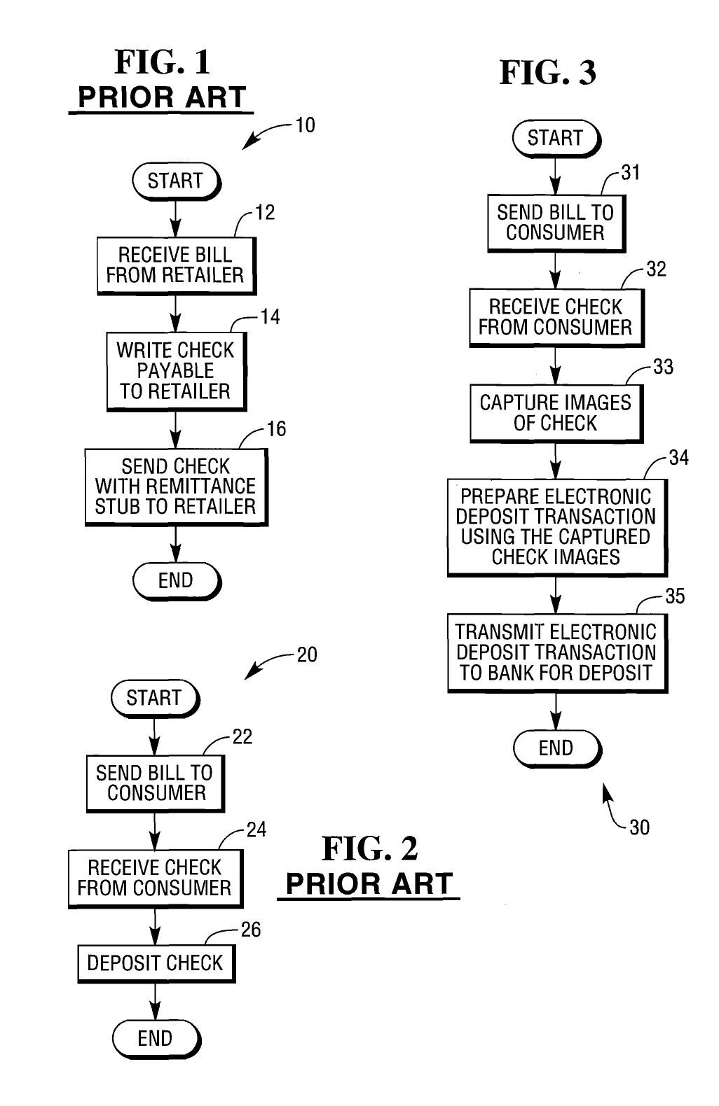

A known method 10 of a retail consumer receiving a bill from a retail merchant and making payment to the retail merchant is shown in FIG. 1. The retail consumer has purchased goods or services from the retail merchant and is making payment therefor. After the retail consumer receives the bill from the retail merchant (step 12), the retail consumer writes a check for the amount due (step 14). The retail consumer then sends the written check with a remittance stub from the bill to the retail merchant (step 16).

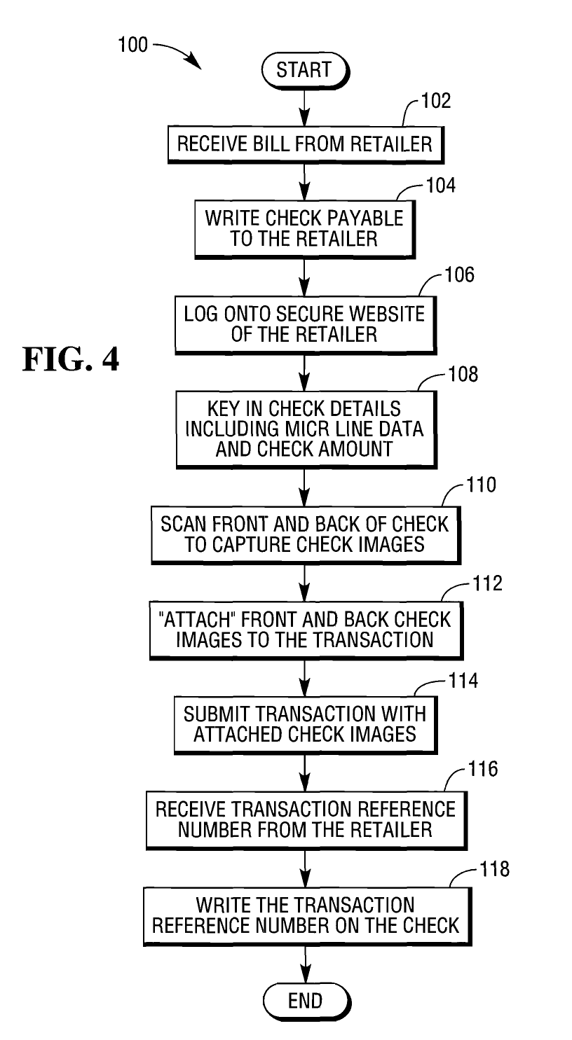

A known billing and payment processing method 20 of a retail merchant is shown in FIG. 2. The method 20 includes the retail merchant sending the bill to the retail consumer who has purchased goods or services from the retail merchant (step 22). After the retail merchant receives the written check for the amount due from the retail consumer (step 24), the retail merchant deposits the check into a bank (step 26).

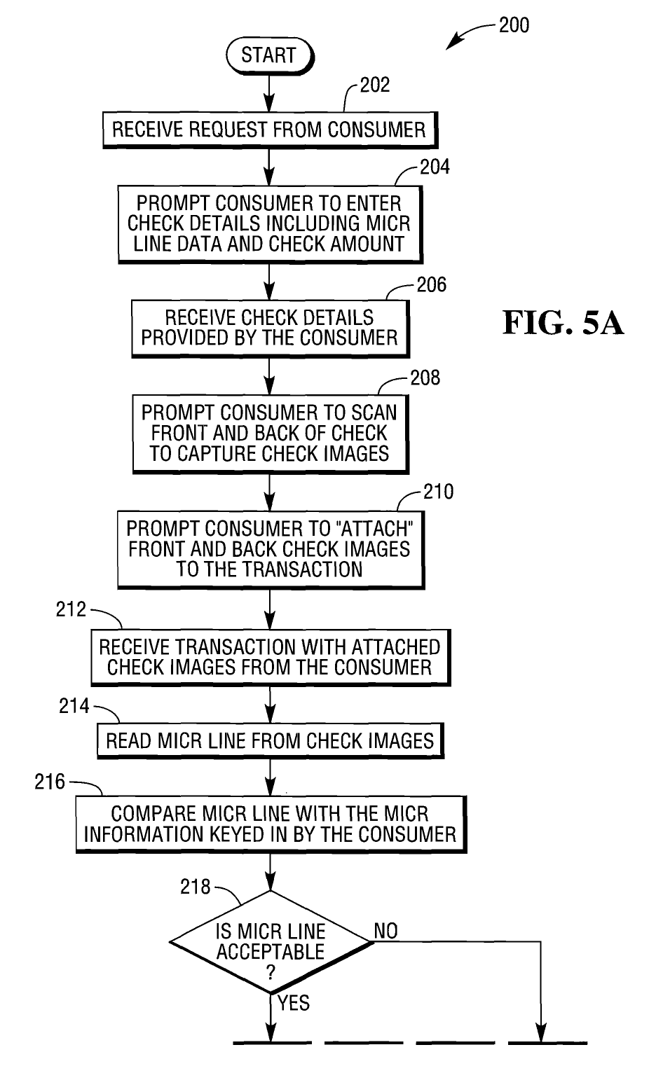

Another known billing and payment processing method 30 of a retail merchant is shown in FIG. 3. The process 30 includes the retail merchant sending the bill to the retail consumer who has purchased goods or services from the retail merchant (step 3 1). After the retail merchant receives the written check for the amount due from the retail consumer (step 32), the retail merchant captures images of the check using an image capture device such as a check scanner (step 33). The captured images comprise an image of the front of the check and an image of the back of the check. The retail merchant then prepares an electronic deposit transaction using the captured check images (step 34), and sends the electronic deposit transaction to the bank for deposit (step 35). The process of creating of an electronic deposit transaction and the subsequent transmitting of the electronic deposit transaction to the bank for deposit are well known and, therefore, will not be described.

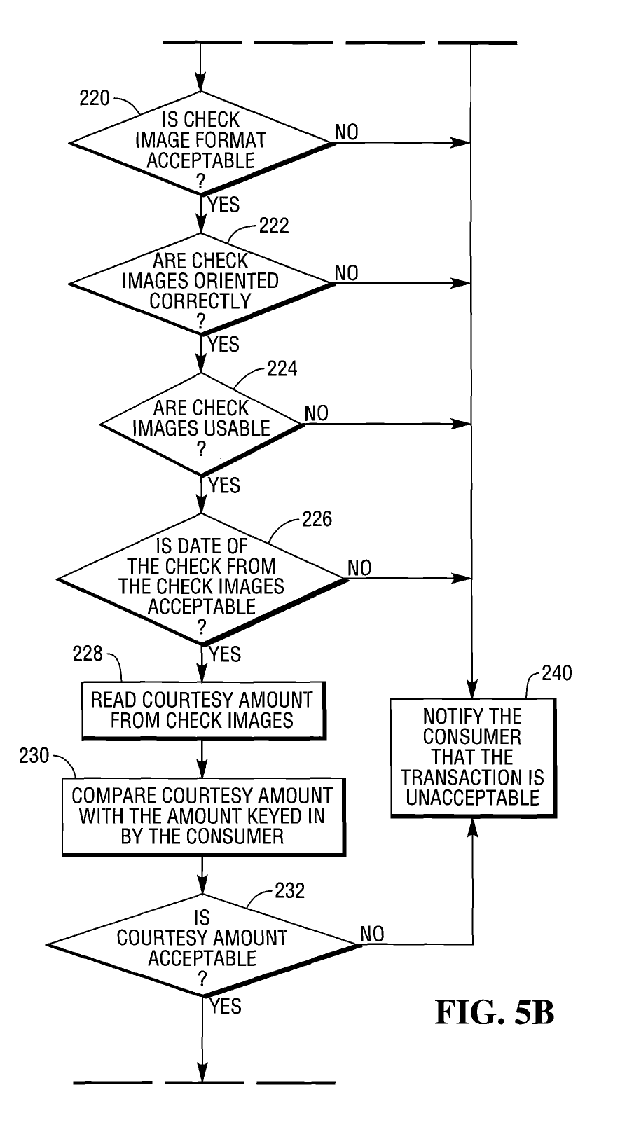

One embodiment of the present invention is illustrated in FIG. 4. FIG. 4 is a flow diagram 100 depicting steps of a retail consumer receiving a bill from a retail merchant and making payment to the retail merchant in accordance with the embodiment of the present invention. After the retail consumer receives the bill from the retail merchant (step 102), the retail consumer writes a check for the amount due (step 104). The retail consumer logs onto a secure website of the retail merchant (step 106) to conduct an on-line payment transaction. The retail consumer keys in details of the particular check including the amount of the check and the magnetic ink character recognition (MICR) codeline associated with the check (step 108).

The retail consumer then uses a scanner device and scans the front and back of the check to capture an image of the front of the check and an image of the back of the check (step 110). The check images are “attached” to the payment transaction (step 112), and submitted with the payment transaction to the retail merchant (step 114). The retail merchant then processes the payment transaction and generates a transaction reference number in a manner to be described later, and sends the transaction reference number to the retail consumer. When the retail consumer receives the transaction reference number from the retail merchant (step 116), the retailer consumer writes the transaction number on the check (step 118).

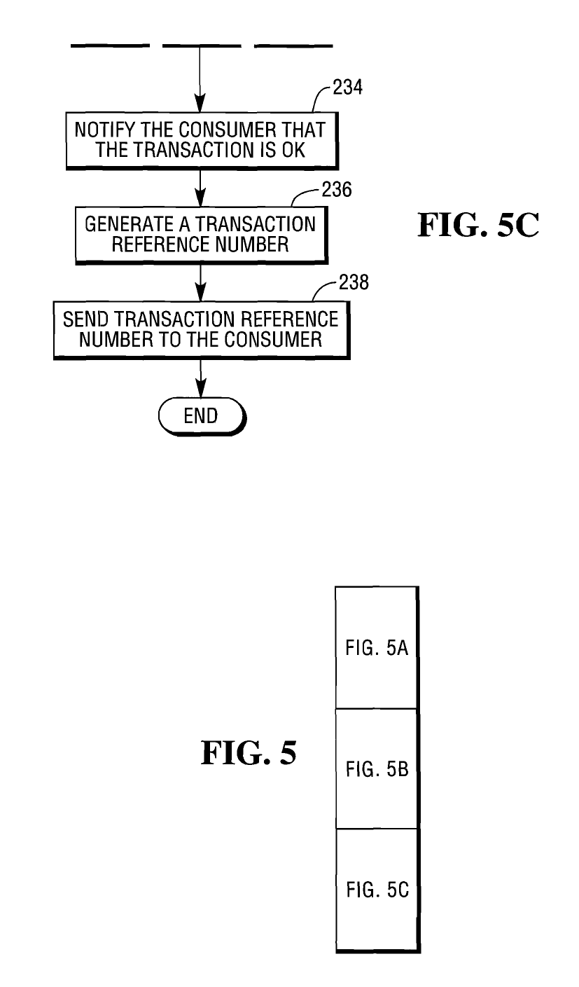

Referring to FIG. 5, a flow diagram 200 depicts steps of a billing and payment processing method used by the retailer merchant in accordance with the embodiment illustrated in FIG. 4. The method 200 includes the retail merchant receiving an on-line request from the retail consumer to conduct a payment transaction via the website of retail merchant (step 202). The retail merchant provides a screen to prompt the consumer to enter check details including the amount of the check and the MICR codeline of the check (step 204). After the retail merchant receives the check details from the consumer (step 206), the retail merchant provides a screen to prompt the retail consumer to scan the front and back of the check to capture an image of the front of the check and an image of the back of the check (step 208). The retail merchant then provides a screen to prompt the retail consumer to attach the check images to the payment transaction (step 210).

After the retail merchant receives the payment transaction along with the attached check images from the retail consumer (step 212), the MICR codeline is read from the check images (step 214) and is compared with the MICR information which was keyed in earlier by the retail consumer (step 216). If the comparison (step 218) is such that the MICR codeline read from the check images does not agree with the MICR information keyed in by the retail consumer, the process proceeds to step 240 to notify the retail consumer that the transaction is unacceptable. However, if the comparison of step 218 is such that the MICR codeline read from the check images does agree with the MICR information keyed in by the retail consumer, the process proceeds to step 220 in which a determination is made as to whether the format of the check images attached to the transaction is acceptable.

If the determination in step 220 is negative, (i.e., the check format is unacceptable), the process proceeds to step 240 to notify the retail consumer that the transaction is unacceptable. However, if the determination in step 220 is affirmative (i.e., the check format is acceptable), the process proceeds to step 222 to make a determination if the orientations of the check images are correct. If the determination in step 222 is negative (i.e., at least one of the check images is incorrectly oriented), the process proceeds to step 240 to notify the retail consumer that the transaction is unacceptable. However, if the determination in step 222 is affirmative (i.e., the check images are correctly oriented), the process proceeds to step 224.

A determination is made in step 224 as to whether the check images are usable. If the determination in step 224 is negative (i.e., the check images are not usable), the process proceeds to step 240 to notify the retail consumer that the transaction is unacceptable. However, if the determination in step is affirmative (i.e., the check images are usable), the process proceeds to step 226 in which a determination is made as to whether the date of the check from the check images is acceptable. If the determination in step 226 is negative (i.e., the check date is unacceptable), the process proceeds to step 240 to notify the retail consumer that the transaction is unacceptable. However, if the determination in step is affirmative (i.e., the check date is acceptable), the process proceeds to step 228.

In step 228, the courtesy amount of the check is read from the check images, and is compared with the courtesy amount information which was keyed in earlier by the retail consumer (step 230). If the comparison (step 232) is such that the courtesy amount read from the check images does not agree with the courtesy amount keyed in by the retail consumer, the process proceeds to step 240 to notify the retail consumer that the transaction is unacceptable. However, if the comparison in step 232 is such that the courtesy amount read from the check images does agree with the courtesy amount keyed in by the retail consumer, the process proceeds to step 234. In step 234, the retail consumer is notified that the transaction is acceptable to be processed. A transaction reference number is then generated (step 236), and is transmitted to the retail consumer (step 238). The process then terminates. It should be apparent that the retail consumer is provided with an alternative method of making payment for a transaction of goods or services provided by the retail merchant. This method allows the retail consumer to use a standard check to make the payment without having to mail the check to the retail merchant. The transaction reference number provided by the retail merchant allows both the retail consumer and the retail merchant to cross reference the transaction with the payment associated with that transaction.

Also, it should be apparent that since the retail merchant receives check images from the retail consumer, the retail merchant need not have to perform the function of scanning the check to capture check images. Check truncation has been achieved at the level of the retail consumer.

Although above-description describes a sequence in which the MICR codeline, the check images format, the check images orientation, the check images usability, the date of the check, and the courtesy amount of the check are considered and determined to be acceptable or not acceptable, it is conceivable not all of these factors need to be considered. It is also conceivable that other factors could be considered. Moreover, it is conceivable that any combination of these factors and other factors could be considered and determined in any sequence.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of a retail merchant in a transaction conducted between the retail merchant and a retail consumer, the method comprising:
receiving an on-line request from the retail consumer to make payment for the transaction;
prompting the retail consumer to key in details associated with a check to be used by the retail consumer to make payment for the transaction;
receiving check details from the retail consumer;
prompting the retail consumer to scan at least one image of the check;
prompting the retail consumer to attach the at least one check image to the transaction; and
receiving the transaction along with the attached check image.

2. A method according to claim 1, wherein receiving check details from the consumer includes receiving magnetic ink character recognition (MICR) codeline data keyed in by the retail consumer.

3. A method according to claim 2, further comprising:
reading MICR codeline data from the check image;
comparing the MICR codeline data from the check image with the MICR codeline data read keyed in by the retail consumer; and
determining if the MICR codeline data read from the check image is acceptable based upon the comparison of the MICR codeline data read from the check image with the MICR codeline data keyed in by the retail consumer.

4. A method according to claim 3, further comprising:
creating a transaction reference number when the MICR codeline data read from the check image is determined to be acceptable.

5. A method according to claim 4, further comprising:
notifying the retail consumer that the transaction is unacceptable when the MICR codeline data read from the check image is determined to be unacceptable.

6. A method according to claim 1, wherein receiving check details from the retail consumer includes receiving a check amount keyed in by the retail consumer.

7. A method according to claim 6, further comprising:
reading a check amount from the check image;
comparing the check amount from the check image with the check amount keyed in by the retail consumer; and
determining if the check amount read from the check image is acceptable based upon the comparison of the check amount read from the check image with the check amount keyed in by the retail consumer.

8. A method according to claim 7, further comprising:
creating a transaction reference number when the check amount read from the check image is determined to be acceptable.

9. A method according to claim 8, further comprising:
notifying the retail consumer that the transaction is unacceptable when the check amount read from the check image is determined to be unacceptable.

10. A method according to claim 6, wherein the check amount comprises the courtesy amount on the check.

11. A method according to claim 1, further comprising
determining if the format of the check details received from the retail consumer is acceptable;
creating a transaction reference number when the format of the check details is determined to be acceptable; and
notifying the retail consumer that the transaction is unacceptable when the format of the check details is determined to be unacceptable.

12. A method according to claim 1, further comprising
determining if the orientation of the check images received from the retail consumer is acceptable;
creating a transaction reference number when the orientation of the check details is determined to be acceptable; and
notifying the retail consumer that the transaction is unacceptable when the orientation of the check images is determined to be unacceptable.

13. A method according to claim 1, further comprising
determining if the check images received from the retail consumer is usable;
creating a transaction reference number when the check images is determined to be usable; and
notifying the retail consumer that the transaction is unacceptable when the check images are determined to be usable.

14. A method according to claim 1, further comprising
reading a date of the check from the check image received from the retail consumer;
determining if the date from the check is acceptable;

15. A method of a retail merchant in a transaction conducted between the retail merchant and a retail consumer, the method comprising:
receiving an on-line request from the retail consumer to make payment for the transaction;
prompting the retail consumer to key in details associated with a check to be used by the retail consumer to make payment for the transaction;
receiving check details including MICR codeline data and a check amount keyed in by the retail consumer;
prompting the retail consumer to scan at least one image of the check;
prompting the retail consumer to attach the at least one check image to the transaction; and
receiving the transaction along with the attached check image;
receiving check details from the retail consumer includes receiving magnetic ink character recognition (MICR) codeline data keyed in by the retail consumer reading MICR codeline data from the check image;
comparing the MICR codeline data from the check image with the MICR codeline data read keyed in by the retail consumer; and
determining if the MICR codeline data read from the check image is acceptable based upon the comparison of the MICR codeline data read from the check image with the MICR codeline data keyed in by the retail consumer.
reading a check amount from the check image;
comparing the check amount from the check image with the check amount keyed in by the retail consumer; and
determining if the check amount read from the check image is acceptable based upon the comparison of the check amount read from the check image with the check amount keyed in by the retail consumer.

16. A method according to claim 15, further comprising:
creating a transaction reference number when the MICR codeline data read from the check image and the check amount read from the check image are determined to be acceptable.

17. A method according to claim 16, further comprising:
notifying the retail consumer that the transaction is unacceptable when the MICR codeline data read from the check image is determined to be unacceptable or when the check amount read from the check image is determined to be unacceptable.
